(19) United States
(12) Patent Application Publication
(10) Pub. No.: US 2015/0271718 A1
(43) Pub. Date: Sep. 24, 2015

(54) APPARATUS AND METHOD FOR PERFORMING INTER-RADIO ACCESS TECHNOLOGY CELL MEASUREMENT

(71) Applicant: QUALCOMM Incorporated, San Diego, CA (US)

(72) Inventors: Thawatt GOPAL, San Diego, CA (US); Scott Allan Hoover, Del Mar, CA (US); Srinivasan Balasubramanian, San Diego, CA (US); Tom Chin, San Diego, CA (US); Daniel Amerga, San Diego, CA (US); Muthukumaran Dhanapal, San Diego, CA (US); Muralidharan Murugan, San Diego, CA (US); Subashini Krishnamurthy, San Diego, CA (US)

(21) Appl. No.: 14/323,656

(22) Filed: Jul. 3, 2014

Related U.S. Application Data
(60) Provisional application No. 61/955,617, filed on Mar. 19, 2014.

(51) Int. Cl. H04W 36/00

(52) U.S. Cl. CPC H04W 36/0088

(57) ABSTRACT

Methods and apparatuses are provided for managing a list of target frequencies for cell measurement. A set of available target frequencies for performing cell measurements from a serving cell can be received, and at least a subset of the set of available target frequencies can be prioritized based at least in part on a list of a plurality of target frequencies stored in a reselection database for the serving cell. Cell measurements can be performed based at least in part on at least the subset of the set of available target frequencies as prioritized. Additionally, the plurality of target frequencies in the reselection database may correspond to target frequencies to which successful reselection has occurred from the serving cell.

### CLAIM OF PRIORITY UNDER 35 U.S.C. §119

The present Application for Patent claims priority to Provisional Application No. 61/955,617 entitled “APPARATUS AND METHOD FOR PERFORMING INTER-RADIO ACCESS TECHNOLOGY CELL MEASUREMENT” filed Mar. 19, 2014, and assigned to the assignee hereof and hereby expressly incorporated by reference herein.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

LTE deployment is limited, however, and as such is not always available to user equipment (UE) traveling over a network coverage area. Other deployments using other radio access technologies (RAT) may be available in these areas, such as TD-SCDMA, and thus some UEs are able to reselect from LTE to TD-SCDMA cells to ensure continuous wireless network access. As such, the UEs can perform inter-RAT measurements to locate cells using the other RATs for potential reselection as LTE coverage degrades. In this regard, the UE can support communications over a number of different frequency layers to facilitate reselection to one of the layers, where LTE and/or other selectable RATs may operate on the different frequency layers. In some cases, cells can broadcast a list of frequency layers that can be evaluated by UEs for reselection, and the UE served by the cells can obtain the list and use the list in measuring other cells for inter-RAT reselection. This list of frequency layers, however, may be large and currently no strategies exist for list ordering. As such, evaluating the frequency list for reselection occurs without planning, and may result in delay where a large number of frequencies are evaluated before encountering a possible cell for reselection, which may also result in loss of LTE coverage before inter-RAT reselection is completed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects, a method of managing a list of target frequencies for cell measurement is provided. The method includes receiving a set of available target frequencies for performing cell measurements from a serving cell, prioritizing at least a subset of the set of available target frequencies based at least in part on a list of a plurality of target frequencies stored in a reselection database for the serving cell, and performing cell measurements based at least in part on at least the subset of the set of available target frequencies as prioritized. In addition, the plurality of target frequencies in the reselection database correspond to target frequencies to which successful reselection has occurred from the serving cell.

In accordance with some aspects, an apparatus for performing channel measurements in a wireless network is provided. The apparatus includes a cell measuring component for receiving a set of available target frequencies for performing cell measurements from a serving cell, a serving cell identifying component for identifying the serving cell in a reselection database, and a reselection database querying component for obtaining a list of a plurality of target frequencies for the serving cell from a reselection database. Also, the cell measuring component prioritizes at least a subset of the set of available target frequencies based at least in part on the list of the plurality of target frequencies and performs cell measurements based at least in part on at least the subset of the set of available target frequencies as prioritized. In addition, the plurality of target frequencies in the reselection database correspond to target frequencies to which successful reselection has occurred from the serving cell.

In accordance with some aspects, an apparatus for performing channel measurements in a wireless network is provided as well. The apparatus includes means for receiving a set of available target frequencies for performing cell measurements from a serving cell, means for identifying the serving cell in a reselection database, and means for obtaining a list of a plurality of target frequencies for the serving cell from a reselection database. The means for receiving prioritizes at least a subset of the set of available target frequencies based at least in part on the list of the plurality of target frequencies and performs cell measurements based at least in part on at least the subset of the set of available target frequencies as prioritized, and the plurality of target frequencies in the reselection database correspond to target frequencies to which successful reselection has occurred from the serving cell.

In accordance with additional aspects, a computer-readable storage medium is provided that includes instructions, that when executed by a processor, cause the processor to perform the steps of receiving a set of available target frequencies for performing cell measurements from a serving cell, prioritizing at least a subset of the set of available target frequencies based at least in part on a list of a plurality of target frequencies stored in a reselection database for the serving cell, and performing cell measurements based at least in part on at least the subset of the set of available target frequencies as prioritized. Additionally, the plurality of target frequencies in the reselection database correspond to target frequencies to which successful reselection has occurred from the serving cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system for performing inter-radio access technology (RAT) reselection;

FIG. 2 is a flow diagram comprising a plurality of functional blocks representing an example methodology for prioritizing one or more frequencies in measuring for reselection;

FIG. 3 is a flow diagram comprising a plurality of functional blocks representing an example methodology of managing a target frequency list for use in measuring for reselection;

FIG. 4 is a flow diagram comprising a plurality of functional blocks representing an example methodology of using a target frequency list to populate an active search list in reselection;

FIG. 5 is a diagram illustrating an example system for communicating between nodes of a wireless network in performing inter-frequency measurements;

FIG. 6 is a diagram illustrating an example of a hardware implementation for an apparatus employing a processing system;

FIG. 7 is a block diagram conceptually illustrating an example of an LTE telecommunications system;

FIG. 8 is a diagram illustrating an example of an access network in an LTE network architecture;

FIG. 9 is a diagram illustrating an example of a radio protocol architecture for the user and control plane, and

FIG. 10 is a diagram illustrating an example of an evolved Node B and user equipment in an access network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents methods and apparatuses for prioritizing target frequencies in inter-radio access technology (RAT) cell reselection based at least in part on a stored list of frequencies maintained for a given serving cell. For example, a reselection database of target frequencies for the serving cell can be utilized and managed, where the reselection database can indicate a list of target frequencies for reselection from a given serving cell along with counters of successful reselections from the serving cell to cells on the target frequencies. In this regard, when measuring cells for reselection, the database can be utilized to obtain the list of target frequencies based at least in part on the number of successful reselections. Thus, frequency or frequencies with the largest number of successful reselections can be measured before those with a lower number of successful reselection and/or those not present in the reselection database for the given serving cell. This can increase the likelihood of successful reselection from the given serving cell by using one of the target frequencies with a number of previous successful reselections from the serving cell, which can also result in reduction of delay between the time when cell measuring begins and reselection occurs.

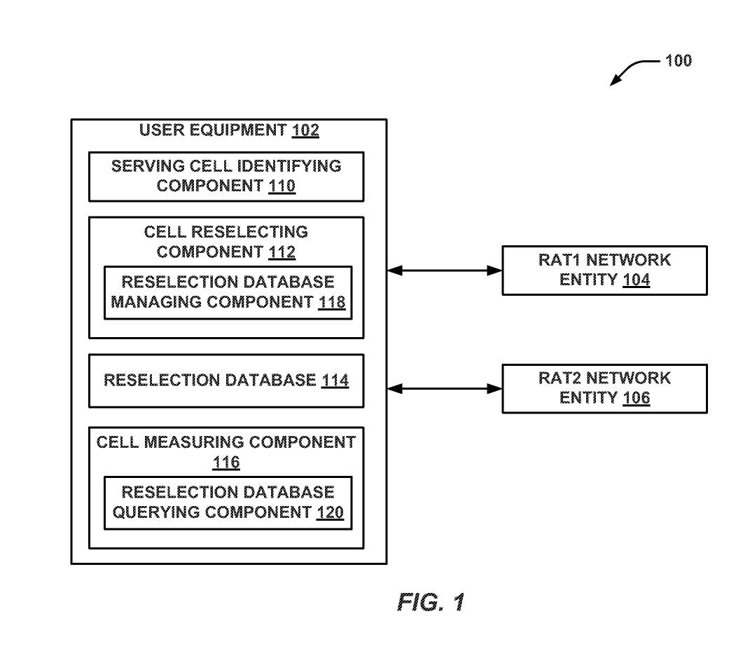

FIG. 1 is a schematic diagram illustrating a system 100 for wireless communication, according to an example configuration. FIG. 1 includes a UE 102 operable to communicate with at least a RAT1 network entity 104 utilizing a first RAT to provide access to a wireless network, and/or a RAT2 network entity 106 using a second RAT to provide access to the same or different wireless network. Though one UE 102 and two network entities 104, 106 are shown, it is to be appreciated that multiple UEs 102 can communicate with network entities 104, 106, and/or additional network entities where the network entities can utilize different RATs to provide access to a wireless network.

UE 102 may comprise any type of mobile device, such as, but not limited to, a smartphone, cellular telephone, mobile phone, laptop computer, tablet computer, or other portable networked device that can be a standalone device, tethered to another device (e.g., a modem connected to a computer), and/or the like. In addition, UE 102 may also be referred to by those skilled in the art as a mobile station, a subscriber station, a mobile unit, a subscriber unit, a wireless unit, a remote unit, a mobile device, a mobile communications device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In addition, with the Internet of Things/Everything becoming more prevalent in the future, it would be beneficial to include not just the traditional mobile device, but other types of devices as a mobile apparatus or UE, such as a watch, a personal digital assistant, a personal monitoring device, a machine monitoring device, a machine to machine communication device, etc. In general, UE 102 may be small and light enough to be considered portable and may be configured to communicate wirelessly via an over-the-air communication link using one or more over-the-air (OTA) communication protocols described herein. Additionally, in some examples, UE 102 may be configured to facilitate communication on multiple separate networks via multiple separate subscriptions, multiple radio links, and/or the like.

Furthermore, network entities 104 and 106 may comprise one or more of any type of network module, such as an access point, a macro cell, including a base station (BS), node B, eNodeB (eNB), a relay, a peer-to-peer device, an authentication, authorization and accounting (AAA) server, a mobile switching center (MSC), a mobility management entity (MME), a radio network controller (RNC), a small cell, etc. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a BS, an access point, a femto node, a femtocell, a pico node, a micro node, a Node B, eNB, home Node B (HNB) or home evolved Node B (HeNB). Therefore, the term “small cell,” as used herein, refers to a relatively low transmit power and/or a relatively small coverage area cell as compared to a macro cell. Additionally, network entity 104 may communicate with one or more other network entities of wireless and/or core networks

Additionally, network entities 104 and 106 can each utilize a different RAT, such as, but not limited to, wide-area networks (WAN), wireless networks (e.g. 802.11 or cellular network), the Public Switched Telephone Network (PSTN) network, ad hoc networks, personal area networks (e.g. Bluetooth®®) or other combinations or permutations of network protocols and network types. Such network(s) may include a single local area network (LAN) or wide-area network (WAN), or combinations of LANs or WANs, such as the Internet. Such networks may comprise a Wideband Code Division Multiple Access (W-CDMA) system, and may communicate with one or more UEs 102 according to this standard. As those skilled in the art will readily appreciate, various aspects described throughout this disclosure may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UEs 102, network entities 104, 106) may be coupled to a core network via one or more wired or wireless connections.

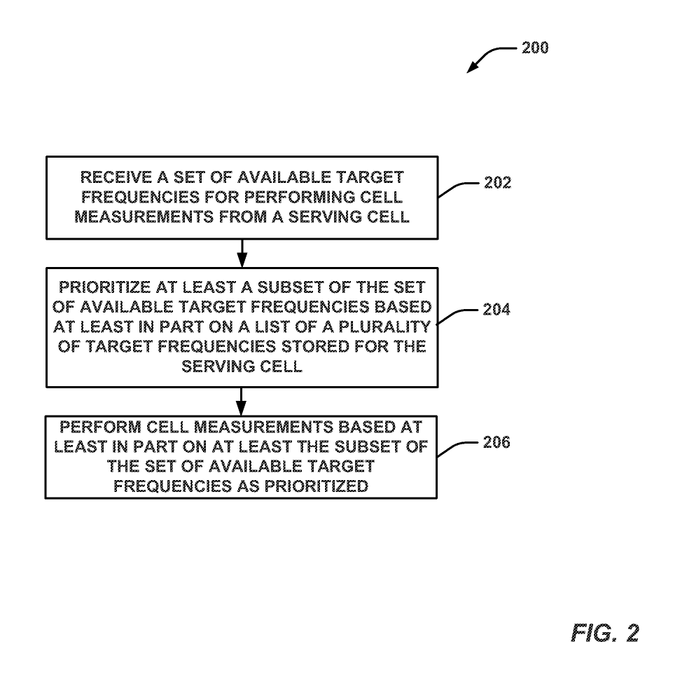

Referring to FIGS. 1-4, aspects of the present apparatus and method are depicted with reference to one or more components and one or more methods that may perform the actions or functions described herein. Although the operations described below in FIGS. 2-4 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

UE 102 includes a serving cell identifying component 110 for obtaining an identifier of a serving cell, such as RAT network entity 104 or a related cell, a cell reselecting component 112 for performing reselection from the serving cell to a target cell on the same or different frequency, such as RAT2 network entity 106 or a related cell, a reselection database 114 for storing information related to the reselection for subsequent use in measuring cells for reselection, and a cell measuring component 116 for performing measurement of cells on one RAT while communicating in a cell of a different RAT. In addition, cell reselecting component 112 includes a reselection database managing component 118 for storing information related to cell reselection in the reselection database 114, and cell measuring component 116 includes a reselection database querying component 120 for utilizing the information stored in the reselection database 114 in measuring cells for reselection. Aspects described herein include utilizing the reselection database 114 in performing inter-RAT reselections, such as aspects for populating and managing the reselection database 114, and aspects of querying and utilizing the database to determine information for performing inter-RAT reselections.

In an example, UE 102 can communicate with RAT1 network entity 104 over a serving frequency to receive access to a wireless network (not shown). RAT1 can be a preferred RAT, for example, where the UE 102 attempts to communicate using RAT1 when possible, and indeed, cell reselecting component 112 can reselect to other network entities the utilize RAT1 on the same or different frequency, where such entities are detected. Cell reselecting component 112, however, can also be configured to reselect to RAT2 when RAT1 coverage is unavailable and/or is determined to be of low quality according to one or more metrics. In this regard, cell measuring component 116 enables measuring signals of other cells that utilize the same or other RATs over the same or different frequencies (e.g., frequencies outside of the serving frequencies of the preferred RAT). Cell measuring component 116, for example, can perform measurements over different frequencies by tuning a receiver to the frequencies during certain intervals, which can include tuning the receiver that communicates with RAT1 away from the serving frequency during the intervals. For example, UE 102 can communicate with RAT1 network entity 104 in an idle mode, and can accordingly tune away to one or more other frequencies during known time intervals during which communications (e.g., paging signals) from the RAT1 network entity 104 are not expected.

Cell measuring component 116 can measure cells over a list of frequencies (e.g., in one or more time intervals in idle mode), where the list can be received from RAT1 network entity 104 in an example. In addition, for example, cell measuring component 116 may begin measuring the other cells when communications with RAT1 network entity 104 degrade to less than a threshold level (e.g., when a reference signal received power (RSRP), reference signal code power (RSCP), signal-to-noise ratio (SNR), etc. is less than a threshold level). In addition, for example, cell measuring component 116 can first attempt to measure cells on other frequencies for the same RAT as RAT1 network entity 104 before measuring cells on RAT2 frequencies. If a measured cell has communication metrics at least at a threshold level while communication metrics for RAT1 network entity 104 are degraded to less than a threshold level, for example, cell reselecting component 112 can determine to perform reselection from the cell provided by RAT1 network entity 104 to the measured cell for accessing the wireless network. In the examples described below, the measured cell to which the cell reselecting component 112 reselects can be provided by RAT2 network entity 106. Cell reselecting component 112, in this regard, can switch communications to instead communicate with the RAT2 network entity 106 to receive access to the wireless network, which includes the cell reselecting component 112 switching UE 102 to use RAT2 and an associated target frequency of the cell provided by RAT2 network entity 106. This can include switching a transceiver of UE 102 to utilize the target frequency, switching an associated processor to process signals defined by RAT2, and/or the like.

In an example, cell measuring component 116 can measure a plurality of frequencies in a search list for reselection, which can include at least a portion of a list of available target frequencies received from RAT1 network entity 104 (e.g., in a broadcast message). In this regard, cell measuring component 116 can measure each frequency in a different time interval, multiple frequencies in a given time interval, etc., and can determine if a suitable cell for reselection is measured in a given interval. This can take some time, for example, where some target frequencies may not have suitable cells communicating over the target frequencies in the location of the UE. Additionally, for a given serving cell, frequencies having suitable cells may be relatively consistent over time. To this end, the UE 102 can populate reselection database 114 with information regarding successful reselections from given serving cells on target frequencies, and can utilize this information in populating a search list for subsequently measuring cells for reselection from the serving cell with those target frequencies having a number of successful reselections.

A method 200 (FIG. 2) of wireless communication is depicted for prioritizing frequencies for cell measurement. Method 200 includes, at Block 202, receiving a set of available target frequencies for performing cell measurements from a serving cell. For example, UE 102 (FIG. 1) includes cell measuring component 116 for receiving the set of available target frequencies from RAT1 network entity 104. The set of available target frequencies can include frequencies of RAT2 for performing inter-RAT cell measurements for reselection to RAT2. As described, for example, receipt of the set of available target frequencies from RAT1 network entity 104 can trigger a process for performing of the cell measurements (e.g., periodically, based on detecting an occurrence of an event, such as RAT1 signal quality degrading below a threshold, etc.).

Method 200 also includes, at Block 204, prioritizing at least a subset of the set of available target frequencies based at least in part on a list of a plurality of target frequencies stored for the serving cell. Thus, for example, serving cell identifying component 110 may identify the serving cell provided by RAT1 network entity 104 (e.g., based on a global cell identifier or other indicated identifier thereof), and reselection database querying component 120 can obtain the list of the plurality of target frequencies stored for the identifier of the serving cell in reselection database 114. Example aspects for populating and formatting the reselection database 114 are described further herein, and can be based on successful reselection from the serving cell to the list of the plurality of target frequencies. Thus, for example, the list of the plurality of target frequencies corresponds to frequencies over which successful reselections have occurred from the serving cell. The list of frequencies for one or more serving cells can be stored in the reselection database 114 in the memory of the UE 102. If the serving cell identifier is not in the reselection database 114, for example, the serving cell identifier may be added to the reselection database 114 for tracking successful reselections from the serving cell to target frequencies on RAT2, which may be based on additional considerations as described further herein.

Method 200 further includes, at Block 206, performing cell measurements based at least in part on at least the subset of the set of available target frequencies as prioritized. Thus, for example, UE 102 includes cell measuring component 116 for measuring the prioritized subset of available target frequencies. This can include cell measuring component 116 populating an active search list (e.g., at Layer 1, also referred to as the physical or PHY layer) for measuring cells as part of idle mode cell reselection. In this example, cell measuring component 116 can initially populate the active search list with at least a portion of frequencies indicated in the reselection database 114 for the serving cell (e.g., at least a portion of the frequencies indicated in the reselection database that are also in a list of target frequencies received from the RAT1 network entity 104). Thus, frequencies over which successful reselection from the serving cell has occurred can be measured first (e.g., and in an order of a number of successful reselections from the serving cell).

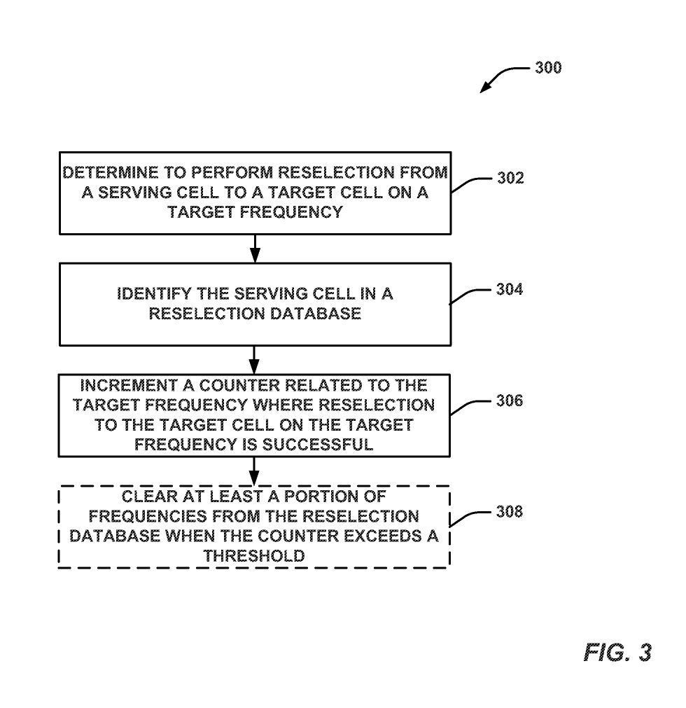

FIG. 3 illustrates an example method 300 for populating the reselection database 114. Method 300 includes, at Block 302, determining to perform reselection from a serving cell to a target cell on a target frequency. In an aspect, for instance, UE 102 may include the cell reselecting component 112 for determining to perform the reselection. As described, for example, cell reselecting component 112 may determine to perform the reselection based at least in part on cell measuring component 116 performing measurements of other cells where communications with the serving cell (e.g., a cell provided by RAT network entity 104) have degraded below a threshold level. In this example, cell reselecting component 112 can determine to perform reselection where another cell (e.g., a cell provided by RAT2 network entity 106) communicating over a measured target frequencies has communication metrics that achieve or exceed a threshold level. It is to be appreciated that cell measuring component 116 can perform measurements over frequencies other than a serving frequency and/or of cells using RAT(s) other than a RAT of the serving cell, as described. As described herein, the frequencies and/or RATs to be measured may be at least partially defined in system information received from RAT1 network entity 104.

The method 300 also includes, at Block 304, identifying the serving cell in a reselection database. UE 102 includes serving cell identifying component 110 for identifying the serving cell and/or determining whether information for the serving cell is present in the reselection database 114. For example, serving cell identifying component 110 can identify the current serving cell based at least in part on an identifier broadcasted by RAT1 network entity 104 when initiating communications therewith in the serving cell.

The method 300 further includes, at Block 306, incrementing a counter related to the target frequency where reselection to the target cell on the target frequency is successful. Cell reselecting component 112 includes a reselection database managing component 118 for incrementing the counter. For example, where reselection database 114 includes information for the identified serving cell (e.g., a list of target frequencies and associated successful reselection counters), reselection database managing component 118 can increment a counter associated with the target frequency in the information of the serving cell. The counter can be used in determining target frequencies for measuring as part of a subsequent reselection from the serving cell.

It is to be appreciated that memory capacity at the UE 102 that is defined for the list of target frequencies for a given serving cell can be limited to a set number of frequencies. Thus, where the information of the serving cell does not include the target frequency in the list of target frequencies, for example, reselection database managing component 118 can determine if there is capacity available in the list to include the target frequency (e.g., if one or more frequency values in the list are indicated as NULL), and if so can include the target frequency in the list and may increment its counter to one. If not, reselection database managing component 118 may not include the target frequency in the reselection database 114 for the serving cell and/or may drop another target frequency for the serving cell having the lowest number of successful reselections in favor of including the target frequency, etc.

If information for the serving cell is not present in the reselection database 114 at all, for example, reselection database managing component 118 can create an entry in the reselection database 114 for the serving cell, and can include a list of target frequencies for performing cell measurements. For example, this initial list of target frequencies can include at least a portion of the list of frequencies received from RAT1 network entity 104 (e.g., received in system information from the RAT1 network entity 104). In this example, the initial list of target frequencies may be populated as a portion of the list of frequencies received where memory capacity for the reselection database 114 is limited. In addition, in this example, reselection database managing component 118 can initialize counters for each frequency included in the list to zero. Subsequently, reselection database managing component 118 can increment counters in the reselection database 114 for target frequencies successfully reselected from the serving cell, and/or the like, as described, to generate the list of target frequencies having successful reselections from the serving cell.

In any case, it is to be appreciated that cell reselecting component 112 can determine when successful inter-RAT cell reselection is performed to another frequency, and/or that the UE 102 is camped on the frequency with a cell of another RAT. For example, this can be based on cell reselecting component 112 detecting successful establishment of communications with the cell of RAT2 network entity 106. For instance, cell reselecting component 112 may detect successful establishment of communications based at least in part on receiving an internal indication from UE's target cell protocol operations related to reselections (e.g., for the RAT2 protocol), which may be based on determining that the UE 102 is able to acquire the target cell using RAT2 communication technology and/or is able to read relevant broadcast messages on RAT2 over the frequency. As such, reselection database managing component 118 can update reselection database 114 with information regarding the successful cell reselection upon determining that the reselection was successful, where the information can include incrementing the counter for the target frequency of the reselection.

In addition, in an example, the method 300 may optionally include, at Block 308, clearing at least a portion of frequencies from the reselection database when the counter exceeds a threshold. In this example, when the counter for the target frequency exceeds the threshold, the reselection database managing component 118 can roll over the counter to one, and can clear a portion of the frequencies from the list of target frequencies for the serving cell. This can allow for discovering additional frequencies over time that may prove to result in an increased probability of successful reselection. In one example, reselection database managing component 118 can keep the target frequency in the list along with at least one of a certain number of frequencies in the list having the next highest counter values, frequencies having a counter value at least at a threshold level, and/or the like. In addition, in one example, reselection database managing component 118 can set the counter values for the additional target frequencies kept in the list to one as well. Maintaining this list of target frequencies for the serving cell and utilizing the list in performing cell measurements, as described herein, can result in improved cell reselection from the serving cell and thus lower delay in performing reselection.

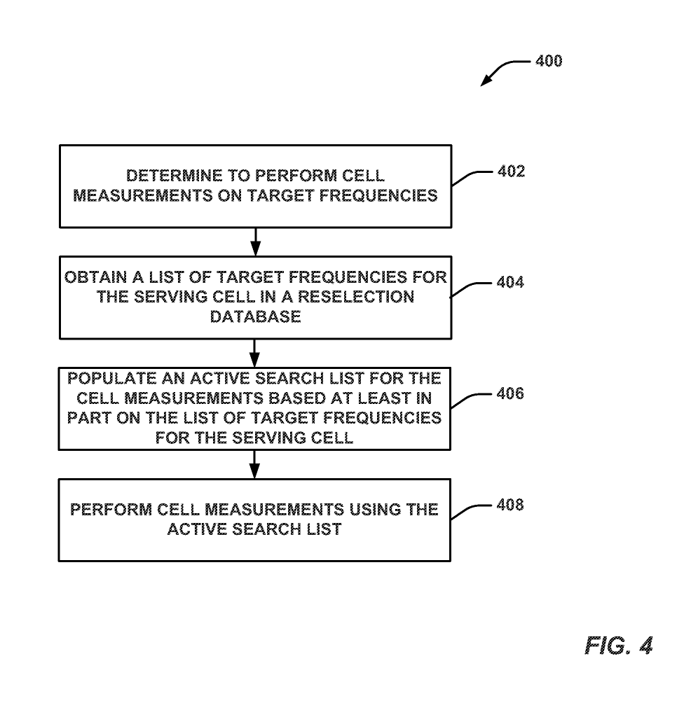

FIG. 4 illustrates an example method 400 of wireless communication for utilizing the reselection database in performing inter-RAT cell measurements for reselection. This can occur, for example, when the UE 102 has subsequently switched back to communicating in the serving cell provided by RAT1 network entity 104 after populating the reselection database 114 with one or more target frequencies or related successful reselection counter values. Method 400 includes, at Block 402, determining to perform cell measurements on target frequencies. In an aspect, for instance, UE 102 may include the cell measuring component 116 for determining to perform the cell measurements. As described, for example, cell measuring component 116 may determine to perform the cell measurements to evaluate other RATs for reselection. This may occur, for example, where cell measuring component 116 detects that service in a first RAT (e.g., provided by RAT1 network entity 104) degrades to a level that is less than a threshold level. This can be determined, for example, based on detecting a communication parameter related to a serving cell or base station (e.g., RAT1 network entity 104), such as a RSRP, RSCP, SNR, etc., as less than a threshold value. As described, as part of performing cell measurements, cell measuring component 116 can populate one or more search lists that include target frequencies to be measured. In one example, the search lists can include an active search list that specifies a limited number of target frequencies to actually measure and/or a dormant search list that specifies another set of target frequencies for which a record exists, but should not be initially measured.

In addition, for example, UE 102 can receive a list of available target frequencies from RAT1 network entity 104 based at least in part on one or more messages broadcasted by RAT1 network entity 104 (e.g., system information block (SIB) messages, such as SIB6 if RAT1 is LTE RAT) and/or one or more dedicated messages therefrom. This list of target frequencies sent by RAT1 network entity 104 can include frequencies of other RATs (e.g., referred to as inter-RAT frequencies), such as one or more frequencies related to RAT2, that the UE 102 can measure as part of inter-RAT reselection. Moreover, reselection database 114 may include a list of target frequencies for the current serving cell, as populated by cell reselecting component 112 described above, which may be prioritized in performing inter-RAT measurement of the target frequencies in some examples.

In this regard, the method 400 includes, at Block 404, obtaining a list of target frequencies for the serving cell in a reselection database. The cell measuring component 116 can include the reselection database querying component 120 for obtaining the list of target frequencies. In one example, the current serving cell (e.g., provided by RAT1 network entity 104) is identified (e.g., based on serving cell identifying component 110 determining an identifier of the serving cell), and reselection database querying component 120 can query the reselection database 114 for the list of target frequencies, and related successful reselection counters, for the identified serving cell. In another example, it is to be appreciated that reselection database querying component 120 can obtain a ranked list of the target frequencies with or without the counter information from reselection database 114.

In any case, the method 400 includes, at Block 406, populating an active search list for the cell measurements based at least in part on the list of target frequencies for the serving cell. Cell measuring component 116 can populate a search list with the obtained target frequencies. For example, cell measuring component 116 can populate an active search list with at least a portion of the obtained frequencies in order beginning with the frequency having the highest counter for successful reselection from the serving cell, or can populate the active search list with the target frequencies in ranked order, where received in a ranked order from reselection database 114.

In addition, in an example, cell measuring component 116 also receives the list of available target frequencies from RAT1 network entity 104 (e.g., in a broadcast message), and can populate the active search list to include target frequencies from the list of target frequencies obtained from reselection database 114 that are also present in the set of the list of available target frequencies received from RAT1 network entity 104. Cell measuring component 116 can order the active search list in this example as well based on reselection counter value for the target frequencies as obtained from the reselection database 114 (e.g., such that target frequencies with higher reselection counter value are prioritized over those with lower reselection counter values). Where additional space remains in the active search list after including the list of target frequencies obtained from reselection database 114, cell measuring component 116 may populate the remainder of the active search list with at least a portion of the list of available target frequencies received from RAT1 network entity 104 that were not in the list of target frequencies obtained from reselection database 114. In addition, for example, cell measuring component 116 may populate a dormant search list with remaining target frequencies received in the list of available target frequencies from RAT1 network entity 104 that were not populated in the active search list.

The method 400 further includes, at Block 408, performing cell measurements using the active search list. In this example, cell measuring component 116 can tune away from communicating with RAT1 network entity 104 in certain time intervals, and can tune to a frequency indicated in the active search list (e.g., beginning with the first frequency) to evaluate cells for possible reselection. As described, for example, cell measuring component 116 can perform measurements over at least a portion of the target frequencies in the active search list, and can determine whether to perform reselection to another cell on the target frequencies based at least in part on the measurements. As described, this can increase the chance of successful reselection from the serving cell (and/or lessen the amount of time required to perform reselection) because the target frequencies that are successfully reselected from the serving cell over time are measured before other frequencies. As described above, upon successful reselection, the method 200 can be performed to again update the reselection database 114.

In a specific example, RAT1 network entity 104 can communicate using LTE, and RAT2 network entity 106 can communicate using TD-SCDMA. Thus, LTE can be preferred where signal quality is desirable, but the UE 102 can reselect to use TD-SCDMA where the LTE signal is less than a threshold level, such to provide continuous access to the wireless network. Moreover, in an example, the reselection database 114 may have a format similar to the following:

| RAT1 | | | | | | | | |
|---|---|---|---|---|---|---|---|---|
| Global | RAT2 | | RAT2 | | RAT2 | | RAT2 | |
| Cell ID | Freq 1 | Count | Freq2 | Count | Freq3 | Count | Freq4 | Count |
| ID#1 | Freq | N1 | Freq | N2 | Freq | N3 | Freq | N4 |
| | ID#1 | | ID#2 | | ID#3 | | ID#4 | |
| ID#2 | Freq | N1 | Freq | N2 | Null | Null | Null | Null |
| | ID#1 | | ID#2 | | | | | |
| ID#3 | Freq | N1 | Null | Null | Null | Null | Null | Null |
| | ID#1 | | | | | | | |
| . . . | | | | | | | | |

In this example, the global cell identifiers for RAT1 are listed. It is to be appreciated that reselection database 114 can store a row in the table for each RAT1 global cell identifier encountered (e.g., an LTE global cell identifier that can uniquely identify the LTE cell, or another unique identifier of the serving cell). For each global cell identifier, a list of one or more RAT2 frequencies are populated, which can include a frequency identifier that specifies the frequency or frequency band, an enumeration representative of the frequency or frequency band, a related identifier from which the frequency can be determined (e.g., a UMTS terrestrial radio access (UTRA) Absolute Radio Frequency Channel Number (UARFCN) in TD-SCDMA), etc. Though storage for four possible RAT2 frequency identifiers are shown in the table above, it is to be appreciated that the reselection database 114 can store substantially any number of RAT2 frequencies (e.g., to balance memory conservation and reselection frequency options). For each RAT2 frequency, a counter value N1-N4 is shown to indicate the number of successful reselections.

Moreover, though shown as involving RAT1 and RAT2, it is to be appreciated that the reselection database 114 may include RAT frequencies for other RATs as well. In this example, RAT frequencies for other RATs can be included in the same row for each RAT1 identifier such that the frequency with the largest number of reselections is used regardless of RAT and/or can be included in different rows to allow the UE 102 to use the functions described herein in performing cell measurements over a given RAT based on the counter values for frequencies of the RAT.

Moreover, in one example, UE 102 may be operable store the contents of the reselection database 114 in non-volatile memory. This can include storing the contents of the reselection database 114 persistently, when the UE 102 is powered down, or otherwise to maintain the reselection database 114 for future use. Where the reselection database 114 is stored during powering down of the UE 102, upon powering up the UE 102, the reselection database 114 may be obtained from non-volatile storage and used for performing cell measurements, as described.

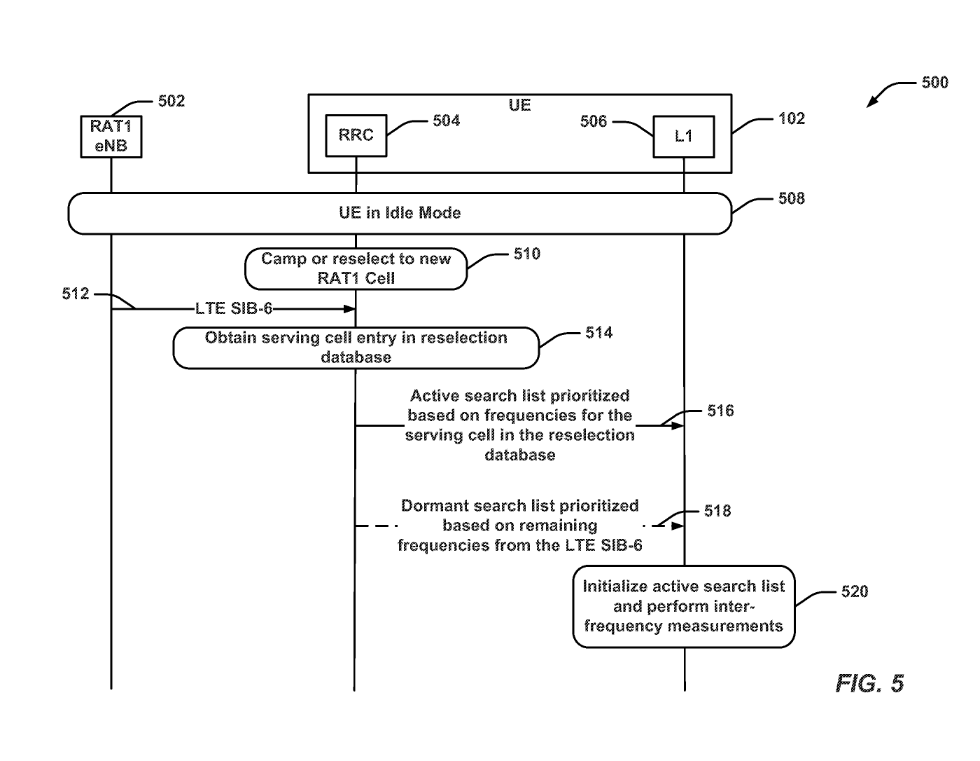

FIG. 5 illustrates an example system 500 for communicating between nodes of a wireless network in performing inter-frequency measurements for cell reselection. System 500 includes a RAT1 eNB 502 that communicates with a UE 102. RAT1 eNB 502, for example, may be similar to and/or include RAT1 network entity 104, as described above. UE 102 can include various communication layers, including an RRC layer 504 and a Layer 1 506, as depicted. RRC layer 504 can be similar to RRC sublayer 916 described herein, and Layer 1 506 can be similar to physical layer 906, described herein. Thus, the UE 102 can also include various layers in between that are not depicted for ease of explanation.

At 508, RAT1 eNB 502 can communicate with UE 102 in idle mode, such that UE 102 is camped on RAT1 eNB 502. In a specific example, RAT1 eNB 502 can be an LTE eNB.

At 510, the RRC layer 504 of UE 102 can determine to camp or reselect to a new RAT1 cell. This may be due to detected degradation in radio quality of a connection with RAT1 eNB 502.

At 512, RRC layer 504 of UE 102 can receive LTE SIB-6 from RAT1 eNB 502, which can include a list of target frequencies to measure in performing inter-RAT cell reselection.

At 514, RRC layer 504 can obtain an entry in the reselection database for the serving cell (e.g., a cell of RAT1 eNB 502), which can include a list of target frequencies to which one or more successful reselections have occurred from the serving cell. As described, RRC layer 504 may obtain the entry based on a determined identifier of the serving cell.

At 516, RRC layer 504 of UE 102 can provide an active search list prioritized based on frequencies for the serving cell in the reselection database to the Layer 1 506 of the UE 102. Thus, for example, the active search list can include target frequencies from the LTE SIB-6 that are also in the reselection database entry for the serving cell, and the active search list can be ordered based on a counter value for each of the frequencies in the reselection entry, as described, such that target frequencies with the highest number of successful reselections from the serving cell are ordered with higher priority such that these frequencies are measured first. The active search list may also include frequencies from the LTE SIB-6 that were not in the reselection database entry once the active search list is populated with frequencies from the reselection database entry if additional space in the active search list remains.

Optionally, at 518, RRC layer 504 can also send a dormant search list prioritized or otherwise populated based on remaining frequencies from the LTE SIB-6. Thus, the dormant search list may include additional frequencies from the LTE SIB-6 that are not in the active search list.

At 520, Layer 1 506 can receive the active search list and/or the dormant search list, and can initialize its active search list with the active search list received at 516 for performing inter-frequency measurements. It is to be appreciated that Layer 1 506 may use the dormant search list in certain cases where searching the active search list did not result in locating candidate cells for reselection. Moreover, for example, where Layer 1 detects a candidate cell on one of the measured frequencies for reselection, and UE 102 successfully reselects to the candidate cell, UE 102 can increment a counter of the frequency for the serving cell in the reselection database, add the frequency to the entry in the reselection database for the serving cell, clear one or more frequencies from the entry where incrementing the counter results in the counter achieving a threshold, etc., as described.

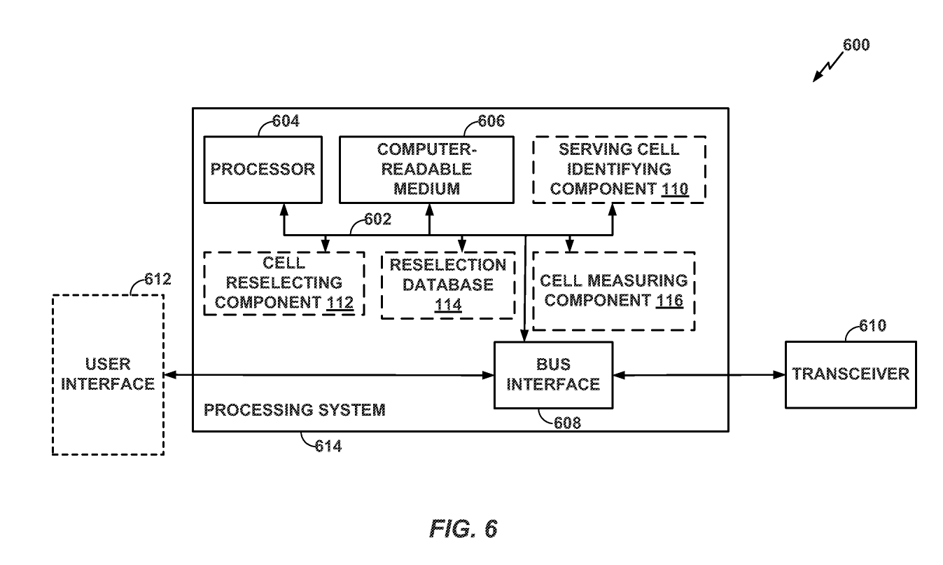

FIG. 6 is a conceptual diagram illustrating an example of a hardware implementation for an apparatus 600 employing a processing system 614. In some examples, the processing system 614 may comprise a UE or a component of a UE (e.g., UE 102 of FIG. 1, etc.), or other network entities (e.g., RAT1 network entity 104 or RAT2 network entity 106 of FIG. 1, RAT1 eNB 502 of FIG. 5, etc.). In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, serving cell identifying component 110, cell reselecting component 112, reselection database 114, cell measuring component 116, etc. (FIG. 1), which may be configured to carry out one or more methods or procedures described herein.

The bus 602 may also link various other circuits such as timing sources, peripherals, voltage regulators, and power management circuits, which are well known in the art. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

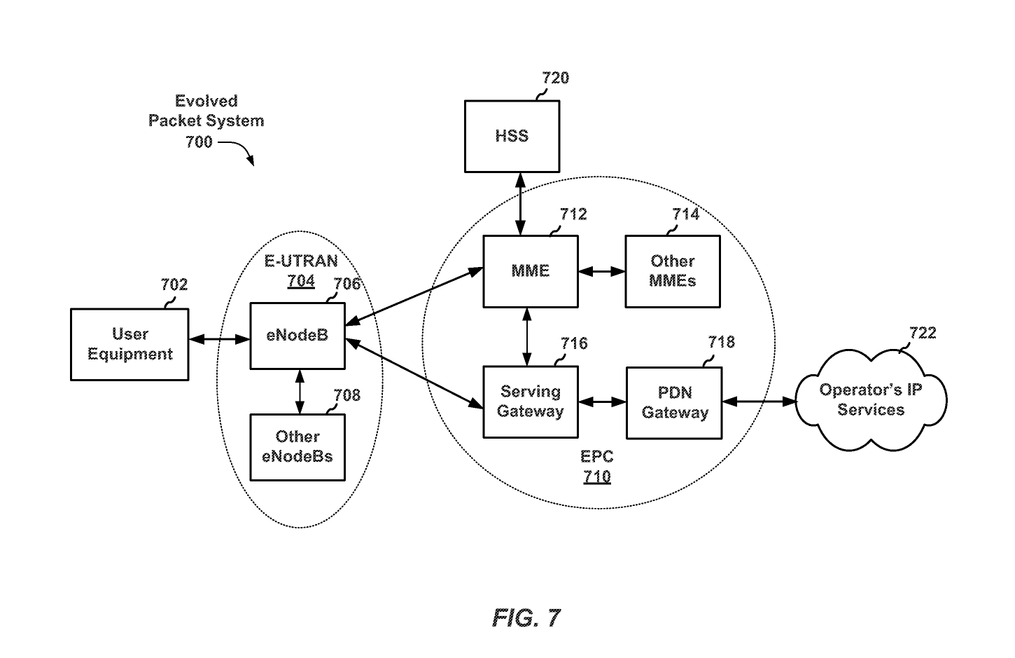

FIG. 7 is a diagram illustrating an LTE network architecture 700 employing various apparatuses (e.g., UE 102 and network entity 104 of FIG. 1). The LTE network architecture 700 may be referred to as an Evolved Packet System (EPS) 700. The EPS 700 may include one or more user equipment (UE) 702 (which may represent UE 102 of FIG. 1), an Evolved UMTS Terrestrial Radio Access Network (E-UTRAN) 704, an Evolved Packet Core (EPC) 710, a Home Subscriber Server (HSS) 720, and an Operator's IP Services 722. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 706 and other eNBs 708, one or more of which may represent RAT1 network entity 104 or RAT2 network entity 106 of FIG. 1, RAT1 eNB 502 of FIG. 5, etc. The eNB 706 provides user and control plane protocol terminations toward the UE 702. The eNB 706 may be connected to the other eNBs 708 via an X2 interface (i.e., backhaul). The eNB 706 may also be referred to by those skilled in the art as a base station, a base transceiver station, a radio base station, a radio transceiver, a transceiver function, a basic service set (BSS), an extended service set (ESS), or some other suitable terminology. The eNB 706 provides an access point to the EPC 710 for a UE 702. Examples of UEs 702 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 702 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 706 is connected by an SI interface to the EPC 710. The EPC 710 includes a Mobility Management Entity (MME) 712, other MMEs 714, a Serving Gateway 716, and a Packet Data Network (PDN) Gateway 718. The MME 712 is the control node that processes the signaling between the UE 702 and the EPC 710. Generally, the MME 712 provides bearer and connection management. All user IP packets are transferred through the Serving Gateway 716, which itself is connected to the PDN Gateway 718. The PDN Gateway 718 provides UE IP address allocation as well as other functions. The PDN Gateway 718 is connected to the Operator's IP Services 722. The Operator's IP Services 722 include the Internet, the Intranet, an IP Multimedia Subsystem (IMS), and a PS Streaming Service (PSS).

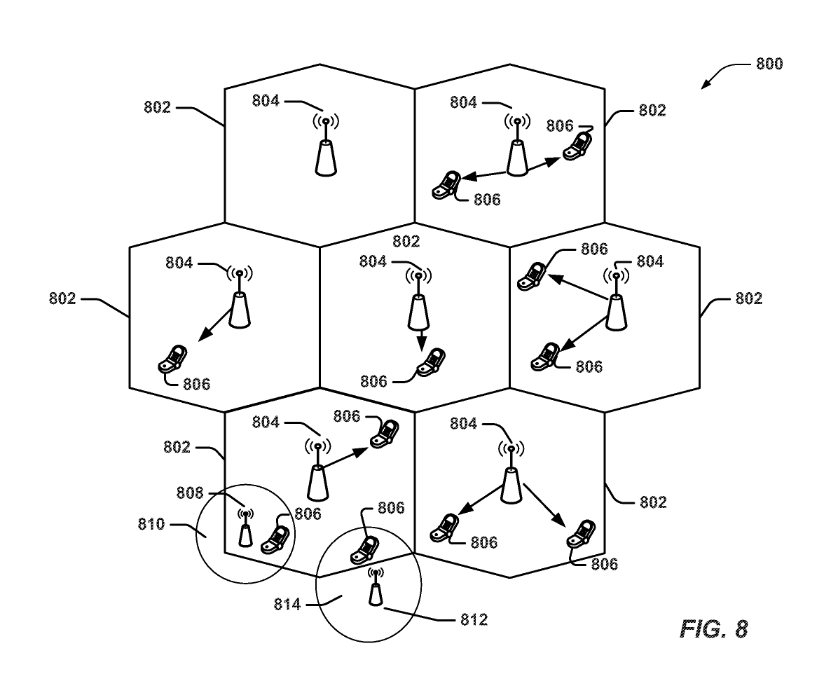

FIG. 8 is a diagram illustrating an example of an access network in an LTE network architecture. In this example, the access network 800 is divided into a number of cellular regions (cells) 802. One or more lower power class eNBs 808, 812 may have cellular regions 810, 814, respectively, that overlap with one or more of the cells 802. The lower power class eNBs 808, 812 may be small cells (e.g., home eNBs (HeNBs)). A higher power class or macro eNB 804 is assigned to a cell 802 and is configured to provide an access point to the EPC 710 for all the UEs 806 in the cell 802. There is no centralized controller in this example of an access network 800, but a centralized controller may be used in alternative configurations. The eNB 804 is responsible for all radio related functions including radio bearer control, admission control, mobility control, scheduling, security, and connectivity to the serving gateway 816. In an aspect, one or more of the eNBs 804, 808, 812 may represent RAT1 network entity 104, RAT2 network entity 106, etc. of FIG. 1, RAT1 eNB 502 of FIG. 5, etc.

The modulation and multiple access scheme employed by the access network 800 may vary depending on the particular telecommunications standard being deployed. In LTE applications, orthogonal frequency-division multiplexing (OFDM) is used on the downlink (DL) and single-carrier frequency division multiple access (SC-FDMA) is used on the uplink (UL) to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 804 may have multiple antennas supporting multiple-input, multiple output (MIMO) technology. The use of MIMO technology enables the eNB 804 to exploit the spatial domain to support spatial multiplexing, beamforming, and transmit diversity.

Spatial multiplexing may be used to transmit different streams of data simultaneously on the same frequency. The data steams may be transmitted to a single UE 806 to increase the data rate or to multiple UEs 806 to increase the overall system capacity. This is achieved by spatially precoding each data stream and then transmitting each spatially precoded stream through a different transmit antenna on the downlink. The spatially precoded data streams arrive at the UE(s) 806 with different spatial signatures, which enables each of the UE(s) 806 to recover the one or more data streams destined for that UE 806. On the uplink, each UE 806 transmits a spatially precoded data stream, which enables the eNB 804 to identify the source of each spatially precoded data stream. In an aspect of the present disclosure, UE 806 may represent UE 102 of FIG. 1.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

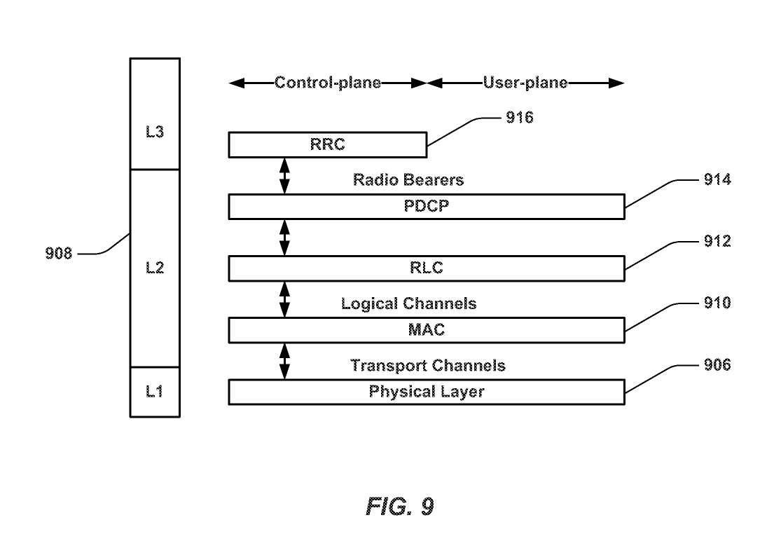

Turning to FIG. 9, the radio protocol architecture for a UE (e.g., UE 102 of FIG. 1) and an eNB (e.g., RAT1 network entity 104 or RAT2 network entity 106 of FIG. 1, RAT1 eNB 502 of FIG. 5, etc.) is shown with three layers: Layer 1, Layer 2, and Layer 3. Layer 1 is the lowest layer and implements various physical layer signal processing functions. Layer 1 will be referred to herein as the physical layer 906. Layer 2 (L2 layer) 908 is above the physical layer 906 and is responsible for the link between the UE and eNB over the physical layer 906.

In the user plane, the L2 layer 908 includes a media access control (MAC) sublayer 910, a radio link control (RLC) sublayer 912, and a packet data convergence protocol (PDCP) 914 sublayer, which are terminated at the eNB on the network side. Although not shown, the UE may have several upper layers above the L2 layer 908 including a network layer (e.g., IP layer) that is terminated at the PDN gateway 718 (see FIG. 7) on the network side, and an application layer that is terminated at the other end of the connection (e.g., far end UE, server, etc.).

The PDCP sublayer 914 provides multiplexing between different radio bearers and logical channels. The PDCP sublayer 914 also provides header compression for upper layer data packets to reduce radio transmission overhead, security by ciphering the data packets, and handover support for UEs between eNBs. The RLC sublayer 912 provides segmentation and reassembly of upper layer data packets, retransmission of lost data packets, and reordering of data packets to compensate for out-of-order reception due to hybrid automatic repeat request (HARQ). The MAC sublayer 910 provides multiplexing between logical and transport channels. The MAC sublayer 910 is also responsible for allocating the various radio resources (e.g., resource blocks) in one cell among the UEs. The MAC sublayer 910 is also responsible for HARQ operations.

In the control plane, the radio protocol architecture for the UE and eNB is substantially the same for the physical layer 906 and the L2 layer 908 with the exception that there is no header compression function for the control plane. The control plane also includes a radio resource control (RRC) sublayer 916 in Layer 3. The RRC sublayer 916 is responsible for obtaining radio resources (i.e., radio bearers) and for configuring the lower layers using RRC signaling between the eNB and the UE.

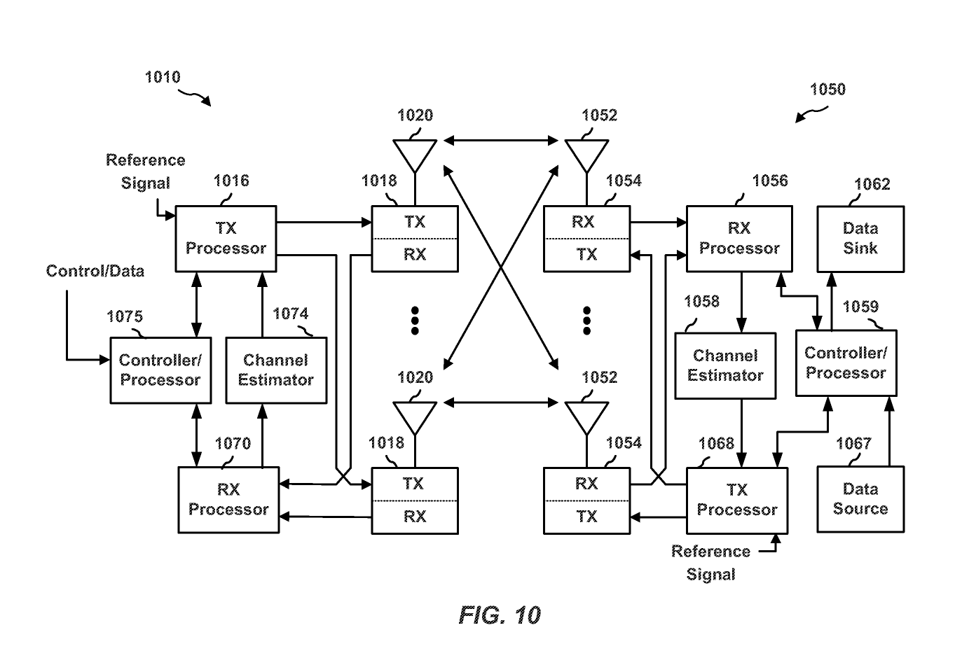

FIG. 10 is a block diagram of an eNB 1010 in communication with a UE 1050 in an access network. In an aspect, eNB 1010 may represent network entity 104 of FIG. 1 and UE 1050 may represent UE 102 of FIG. 1. In the downlink (DL), upper layer packets from the core network are provided to a controller/processor 1075. The controller/processor 1075 implements the functionality of the L2 layer described earlier in connection with FIG. 9. In the DL, the controller/processor 1075 provides header compression, ciphering, packet segmentation and reordering, multiplexing between logical and transport channels, and radio resource allocations to the UE 1050 based on various priority metrics. The controller/processor 1075 is also responsible for HARQ operations, retransmission of lost packets, and signaling to the UE 1050.

The transmit (TX) processor 1016 implements various signal processing functions for the L1 layer (i.e., physical layer). The signal processing functions includes coding and interleaving to facilitate forward error correction (FEC) at the UE 1050 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 1074 may be used to determine the coding and modulation scheme, as well as for spatial processing. The channel estimate may be derived from a reference signal and/or channel condition feedback transmitted by the UE 1050. Each spatial stream is then provided to a different antenna 1020 via a separate transmitter 1018TX. Each transmitter 1018TX modulates an RF carrier with a respective spatial stream for transmission.

At the UE 1050, each receiver 1054RX receives a signal through its respective antenna 1052. Each receiver 1054RX recovers information modulated onto an RF carrier and provides the information to the receiver (RX) processor 1056.

The RX processor 1056 implements various signal processing functions of the L1 layer. The RX processor 1056 performs spatial processing on the information to recover any spatial streams destined for the UE 1050. If multiple spatial streams are destined for the UE 1050, they may be combined by the RX processor 1056 into a single OFDM symbol stream. The RX processor 1056 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 1010. These soft decisions may be based on channel estimates computed by the channel estimator 1058. The soft decisions are then decoded and deinterleaved to recover the data and control signals that were originally transmitted by the eNB 1010 on the physical channel. The data and control signals are then provided to the controller/processor 1059.

The controller/processor 1059 implements the L2 layer described earlier in connection with FIG. 9. In the UL, the control/processor 1059 provides demultiplexing between transport and logical channels, packet reassembly, deciphering, header decompression, control signal processing to recover upper layer packets from the core network. The upper layer packets are then provided to a data sink 1062, which represents all the protocol layers above the L2 layer. Various control signals may also be provided to the data sink 1062 for L3 processing. The controller/processor 1059 is also responsible for error detection using an acknowledgement (ACK) and/or negative acknowledgement (NACK) protocol to support HARQ operations.

In the UL, a data source 1067 is used to provide upper layer packets to the controller/processor 1059. The data source 1067 represents all protocol layers above the L2 layer (L2). Similar to the functionality described in connection with the DL transmission by the eNB 1010, the controller/processor 1059 implements the L2 layer for the user plane and the control plane by providing header compression, ciphering, packet segmentation and reordering, and multiplexing between logical and transport channels based on radio resource allocations by the eNB 1010. The controller/processor 1059 is also responsible for HARQ operations, retransmission of lost packets, and signaling to the eNB 1010.

Channel estimates derived by a channel estimator 1058 from a reference signal or feedback transmitted by the eNB 1010 may be used by the TX processor 1068 to select the appropriate coding and modulation schemes, and to facilitate spatial processing. The spatial streams generated by the TX processor 1068 are provided to different antenna 1052 via separate transmitters 1054TX. Each transmitter 1054TX modulates an RF carrier with a respective spatial stream for transmission.

The UL transmission is processed at the eNB 1010 in a manner similar to that described in connection with the receiver function at the UE 1050. Each receiver 1018RX receives a signal through its respective antenna 1020. Each receiver 1018RX recovers information modulated onto an RF carrier and provides the information to a RX processor 1070. The RX processor 1070 implements the L1 layer.

The controller/processor 1059 implements the L2 layer described earlier in connection with FIG. 9. In the UL, the control/processor 1059 provides demultiplexing between transport and logical channels, packet reassembly, deciphering, header decompression, control signal processing to recover upper layer packets from the UE 1050. Upper layer packets from the controller/processor 1075 may be provided to the core network. The controller/processor 1059 is also responsible for error detection using an ACK and/or NACK protocol to support HARQ operations.

By way of example, various aspects of the present disclosure may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of managing a list of target frequencies for cell measurement, comprising:
receiving a set of available target frequencies for performing cell measurements from a serving cell;
prioritizing at least a subset of the set of available target frequencies based at least in part on a list of a plurality of target frequencies stored in a reselection database for the serving cell; and
performing cell measurements based at least in part on at least the subset of the set of available target frequencies as prioritized,
wherein the plurality of target frequencies in the reselection database correspond to target frequencies to which successful reselection has occurred from the serving cell.

2. The method of claim 1, further comprising:
performing reselection to a cell operating on a target frequency in the subset of the set of available target frequencies; and
incrementing a counter for the target frequency in the list of the plurality of target frequencies in the reselection database.

3. The method of claim 2, further comprising adding the target frequency to the list of the plurality of target frequencies stored in the reselection database for the serving cell.

4. The method of claim 2, further comprising clearing at least a portion of the list of the plurality of target frequencies for the serving cell in the reselection database where incrementing the counter results in the counter achieving a threshold level.

5. The method of claim 2, further comprising determining the reselection is successful based at least in part on receiving an internal indication from a target cell protocol operations related to reselections, wherein incrementing the counter is based at least in part on determining the reselection is successful.

6. The method of claim 1, wherein prioritizing at least the subset of the set of available target frequencies comprises populating an active search list for performing the cell measurements with the subset of the set of available target frequencies.

7. The method of claim 6, wherein prioritizing at least the subset of the set of available target frequencies further comprises populating a dormant search list with another subset of the set of available target frequencies that are not included in the list of a plurality of target frequencies stored in the reselection database for the serving cell.

8. The method of claim 6, wherein populating the active search list occurs at Layer 1.

9. The method of claim 1, further comprising obtaining the list of the plurality of target frequencies for the serving cell based at least in part on determining that an identifier of the serving cell is present in the reselection database.

10. An apparatus for performing channel measurements in a wireless network, comprising:
a cell measuring component for receiving a set of available target frequencies for performing cell measurements from a serving cell;
a serving cell identifying component for identifying the serving cell in a reselection database; and
a reselection database querying component for obtaining a list of a plurality of target frequencies for the serving cell from the reselection database,
wherein the cell measuring component prioritizes at least a subset of the set of available target frequencies based at least in part on the list of the plurality of target frequencies and performs cell measurements based at least in part on at least the subset of the set of available target frequencies as prioritized,
wherein the plurality of target frequencies in the reselection database correspond to target frequencies to which successful reselection has occurred from the serving cell.

11. The apparatus of claim 10, further comprising:
a cell reselecting component for performing reselection to a cell operating on a target frequency in the subset of the set of available target frequencies; and
a reselection database managing component for incrementing a counter for the target frequency in the list of the plurality of target frequencies in the reselection database.

12. The apparatus of claim 11, wherein the reselection database managing component is operable for adding the target frequency to the list of the plurality of target frequencies stored in the reselection database for the serving cell.

13. The apparatus of claim 11, wherein the reselection database managing component is operable for clearing at least a portion of the list of the plurality of target frequencies for the serving cell in the reselection database where incrementing the counter results in the counter achieving a threshold level.

14. The apparatus of claim 11, wherein the cell reselecting component is operable for determining the reselection is successful based at least in part on receiving an internal indication from a target cell protocol operations related to reselections, wherein the reselection database managing component is operable for incrementing the counter based at least in part on determining the reselection is successful.

15. The apparatus of claim 10, wherein the cell measuring component is operable for prioritizing at least the subset of the set of available target frequencies at least in part by populating an active search list for performing the cell measurements with the subset of the set of available target frequencies.

16. The apparatus of claim 15, wherein the cell measuring component is operable for prioritizing at least the subset of the set of available target frequencies at least in part by populating a dormant search list with another subset of the set of available target frequencies that are not included in the list of a plurality of target frequencies stored in the reselection database for the serving cell.

17. The apparatus of claim 15, wherein populating the active search list occurs at Layer 1.

18. The apparatus of claim 10, wherein the reselection database querying component is operable for obtaining the list of the plurality of target frequencies for the serving cell based at least in part on determining that an identifier of the serving cell is present in the reselection database.

19. An apparatus for performing channel measurements in a wireless network, comprising:
means for receiving a set of available target frequencies for performing cell measurements from a serving cell;
means for identifying the serving cell in a reselection database; and
means for obtaining a list of a plurality of target frequencies for the serving cell from the reselection database,
wherein the means for receiving prioritizes at least a subset of the set of available target frequencies based at least in part on the list of the plurality of target frequencies and performs cell measurements based at least in part on at least the subset of the set of available target frequencies as prioritized,
wherein the plurality of target frequencies in the reselection database correspond to target frequencies to which successful reselection has occurred from the serving cell.

20. The apparatus of claim 19, further comprising:
means for performing reselection to a cell operating on a target frequency in the subset of the set of available target frequencies; and
means for incrementing a counter for the target frequency in the list of the plurality of target frequencies in the reselection database.

21. The apparatus of claim 20, wherein the means for incrementing the counter is operable for adding the target frequency to the list of the plurality of target frequencies stored in the reselection database for the serving cell.

22. The apparatus of claim 19, wherein the means for receiving is operable for prioritizing at least the subset of the set of available target frequencies at least in part by populating an active search list for performing the cell measurements with the subset of the set of available target frequencies.

23. The apparatus of claim 22, wherein the means for receiving is operable for prioritizing at least the subset of the set of available target frequencies at least in part by populating a dormant search list with another subset of the set of available target frequencies that are not included in the list of a plurality of target frequencies stored in the reselection database for the serving cell.

24. The apparatus of claim 19, wherein the means for obtaining is operable for obtaining the list of the plurality of target frequencies for the serving cell based at least in part on determining that an identifier of the serving cell is present in the reselection database.

25. A computer-readable storage medium, comprising instructions, that when executed by a processor, cause the processor to perform the steps of:
receiving a set of available target frequencies for performing cell measurements from a serving cell;
prioritizing at least a subset of the set of available target frequencies based at least in part on a list of a plurality of target frequencies stored in a reselection database for the serving cell; and
performing cell measurements based at least in part on at least the subset of the set of available target frequencies as prioritized,
wherein the plurality of target frequencies in the reselection database correspond to target frequencies to which successful reselection has occurred from the serving cell.

26. The computer-readable storage medium of claim 25, further comprising instructions, that when executed by the processor, cause the processor to perform the steps of:
performing reselection to a cell operating on a target frequency in the subset of the set of available target frequencies; and
incrementing a counter for the target frequency in the list of the plurality of target frequencies in the reselection database.

27. The computer-readable storage medium of claim 26, further comprising instructions, that when executed by the processor, cause the processor to perform the step of adding the target frequency to the list of the plurality of target frequencies stored in the reselection database for the serving cell.

28. The computer-readable storage medium of claim 25, further comprising instructions, that when executed by the processor, cause the processor to perform the step of prioritizing at least the subset of the set of available target frequencies at least in part by populating an active search list for performing the cell measurements with the subset of the set of available target frequencies.

29. The computer-readable storage medium of claim 28, further comprising instructions, that when executed by the processor, cause the processor to perform the step of prioritizing at least the subset of the set of available target frequencies at least in part by populating a dormant search list with another subset of the set of available target frequencies that are not included in the list of a plurality of target frequencies stored in the reselection database for the serving cell.

30. The computer-readable storage medium of claim 25, further comprising instructions, that when executed by the processor, cause the processor to perform the step of obtaining the list of the plurality of target frequencies for the serving cell based at least in part on determining that an identifier of the serving cell is present in the reselection database.
